(19) United States
(12) Patent Application Publication
(10) Pub. No.: US 2013/0330625 A1
(43) Pub. Date: Dec. 12, 2013

(54) Lithium Nickel Cobalt Composite Oxide Cathode Material

(71) Applicant: FU JEN CATHOLIC UNIVERSITY, New Taipei City (TW)

(72) Inventors: Mao-Huang LIU, New Taipei City (TW); Hsin-Ta HUANG, New Taipei City (TW)

(73) Assignee: FU JEN CATHOLIC UNIVERSITY, New Taipei City (TW)

(21) Appl. No.: 13/828,519

(22) Filed: Mar. 14, 2013

(30) Foreign Application Priority Data
Jun. 11, 2012 (TW) 101120926

(51) Int. Cl. H01M 4/36; H01M 4/525

(52) U.S. Cl. CPC H01M 4/364; H01M 4/525
USPC 429/223; 252/182.1

(57) ABSTRACT

A lithium nickel cobalt composite oxide cathode material includes a plurality of secondary particles. Each secondary particle consists of aggregates of fine primary particles. Each secondary particle includes lithium nickel cobalt composite oxide, which is expressed as LiₐNi_{1-b}Co_{b}O₂. An average chemical formula of each secondary particle satisfies one condition of 0.9≦a≦1.2, 0.1≦b≦0.5. The lithium nickel cobalt composite oxide has a structure with different chemical compositions of primary particles from the surface toward core of each of the secondary particles. The primary particle with rich Co content near the surface and the primary particle with rich Ni content in the core of secondary particle of the lithium nickel cobalt composite oxide cathode material have provided the advantages of high safety and high capacity.

### CROSS-REFERENCES TO RELATED APPLICATIONS

This application claims the priority of Taiwanese patent application No. 101120926, filed on Jun. 11,2012, which is incorporated herewith by reference.

### BACKGROUND OF THE INVENTION

1. Field of the Invention

The present invention relates to a lithium nickel cobalt composite oxide cathode material, more specifically to a lithium nickel cobalt composite oxide is basically formed secondary particles consisting of aggregates of tine primary particles, each having a structure with different chemical compositions of primary particles from the surface toward core of each of the secondary particles.

2. The Prior Arts

The advance of 3C products and the rising knowledge for environmental protection, electric vehicles draw an important attention for a majority of the people. Regardless of whatever cell system is applied in the electric vehicles, the main request still lies in high energy-density lithium battery. The request of volumetric energy density is already greater than 400 Wh/L. However, the volumetric energy density of lithium battery made from lithium cobalt oxide (LiCoO₂) cathode material is only 320-350 Wh/L, and there is no room to increase the utility performance. Therefore, some researches have proposed lithium nickel oxide (LiNiO₂) cathode material, which has high energy density, low price, and less toxicity are developed for replacing lithium cobalt oxide cathode material. However, the LiNiO₂ is unsafe and poor cycleability. Therefore, LiNiO₂ is difficult to use in lithium battery. Cathode materials of the lithium battery not only influence the performance of the cell, but also decide the safety of the cell. Therefore, a good cathode material for applying in the lithium battery is defined to have high specific. capacity and high thermal stability. In other words, the material applied for the cathode material of lithium battery should provide good safety. In order to solve the problem, some researchers dope cobalt ions having better structural stability into the LiNiO₂ material to replace some nickel ions to synthesize a lithium nickel cobalt composite oxide cathode (LiₐNi_{1-b}Co_{b}O₂) material for improving structural stability and thermal stability. The higher the content of cobalt, the higher the safety is obtained, but lower capacity. It is against the trend in search of high capacity characteristics, which is the basic requirement for a lithium battery.

The lithium nickel cobalt composite oxide cathode material is difficult to commercialize because the safety problem has to be solved. In order to solve the problem, some researching units or manufactures select to dope other metal ions into the structure of the lithium nickel cobalt composite oxide cathode material to raise the structural stability of material. Although the structural stability is more stable and has better safety than pure lithium nickel cobalt composite oxide cathode material, however, the capacity is decreased due to the higher internal impedance or losing lithium ion replaced by doped ion.

In recent years, some researchers have provided a method to coat a nano-protective layer on the surface of lithium nickel cobalt composite oxide in order to prevent the I-IF attack from the electrolyte, thereby ensuring the structure of material. However, the method can decrease the exothermic heat, but is difficult to raise the thermal-decomposition temperature. In. addition, it is hard to control the thickness of coated layer and do the mass production.

Other researchers have proposed a core-shell complex structure of cathode material, in which the lithium nickel cobalt composite oxide is used as a core of cathode material, and a thermal stability cathode material covered on the surface of the lithium nickel cobalt composite oxide to form a protective shell. For example, the thermal stability cathode material is lithium nickel cobalt manganese composite oxide or lithium nickel manganese oxide, and the thickness of the protective shell is 1˜2 μm. This structure greatly improves the safety of material; however, the interface resistance inside the material is also raised, such that the discharge performance is decreased under high-rate test. Moreover, the synthesis of material with core-shell structure is hard to control in mass production.

### SUMMARY OF THE INVENTION

An objective of the present invention to provide a lithium nickel cobalt composite oxide cathode material, which is formed secondary particles consisting of aggregates of fine primary particles. Each secondary particle includes a lithium nickel cobalt composite oxide, which is expressed as LiₐNi_{1-b}Co_{b}O₂, the average chemical formula of secondary particle satisfies one condition of 0.9≦a≦1.2, and 0.1≦b≦0.5. The lithium nickel cobalt composite oxide has a structure with different chemical compositions of primary particles from the surface toward core of each of the secondary particles.

The different chemical compositions of the primary particles in the lithium nickel cobalt composite oxide cathode material are that lithium content is uniformly distributed from the surface toward the core of the secondary particle, nickel content is increased from the surface toward the core of the secondary particle, and cobalt content is decreased from the surface toward the core of the secondary particle.

The formula of primary particle near the surface of the secondary particle of the lithium nickel cobalt composite oxide cathode material is expressed as LiₓNi_{1-y}Co_{y}O₂, wherein 0.9≦x≦1.2, and 0.15≦y≦1.0, and the formula of primary particle in the core of the secondary particle of the lithium nickel cobalt composite oxide cathode material is expressed as Li_{x′}Ni_{1-y′}Co_{y′}O₂, wherein 0.9≦x′≦1.2, 0≦y′≦0.3 and x=x′, y>y′.

The primary particle of the lithium nickel cobalt composite oxide cathode material has an average particle size of 30˜700 nm, and the average particle size (D₅₀) of the secondary particle of the lithium nickel cobalt composite oxide cathode material is 0.5˜25 μm. Moreover, the cathode material is a R-3m rhombohedral structure, and the tap density of the cathode material is greater than 1.5 g/cm³, and specific surface area of the cathode material is within 0.1˜20 m²/g.

Therefore, the lithium nickel cobalt composite oxide cathode material of the present invention consists of primary particles with different chemical formula, the primary particle with rich Co content near the surface of the secondary particle provides a high thermal stability for the material, and the primary particle with rich Ni content in the core of the secondary particle provides a high capacity, such that the lithium nickel cobalt composite oxide cathode material has two advantages above, and satisfy the battery demand of high power, high capacity, and high safety, and suitable to apply in the lithium battery.

### BRIEF DESCRIPTION OF THE DRAWINGS

The present invention can be understood in more detail by reading the subsequent detailed description in conjunction with the examples and references made to the accompanying drawings, wherein:

FIG. 1 is a structure diagram of secondary particle of a cathode material in accordance with the present invention;

FIG. 2(a) shows the morphology and element ratio of the surface of the embodiment. and FIG. 2(b) shows the morphology and compositional change of the cross section of the embodiment;

FIG. 3 is a comparison diagram in the initial charge-discharge curves of (a) comparative example and (b) embodiment in the voltage range of 2.8˜4.3V at current level of 0.1 C;

FIG. 4 is a comparison diagram in the discharge capability at various currents between (a) comparative example and (b) embodiment;

FIG. 5 is a comparison diagram in cycle life of (a) comparative example and (b) embodiment; and

Fig, 6 is a comparison diagram tested by a differential scanning calorimeter with regard to released heat-flow of (a) comparative example and (b) embodiment.

### DETAILED DESCRIPTION OF THE PREFERRED EMBODIMENTS

The details of the preferred embodiments of the present invention will be described in the subsequent content with reference to the accompanying drawings, such that the present invention can be implemented people with skills based on the content.

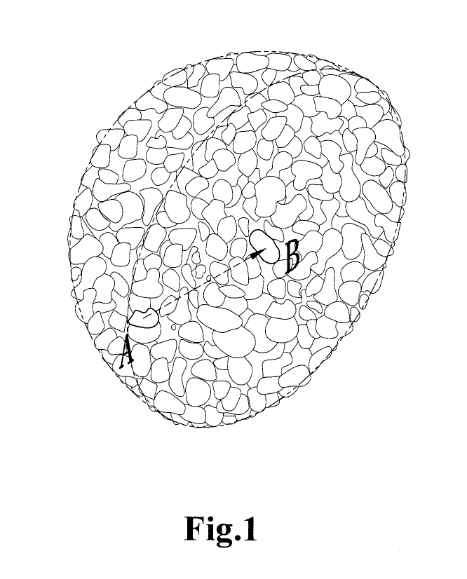

FIG. 1 illustrates a structure diagram of secondary particle of the lithium nickel cobalt composite oxide of the present invention. The lithium nickel cobalt composite oxide cathode material includes a plurality of secondary particles; each secondary particle consists of aggregates of fine primary particles. Each secondary particle includes a lithium nickel cobalt composite oxide, which is expressed as LiₐNi_{1-b}Co_{b}O₂.,The average chemical formula of each secondary particle satisfies one condition of 0.9≦a≦1.2, and 0.1≦b≦0.5. The lithium nickel cobalt composite oxide has a structure with different chemical compositions of primary particles from the surface toward core of each of the secondary particles.

As shown in FIG. 1, A is one primary particle near the surface of the secondary particle while B is the core of the secondary particle.

The different chemical compositions of the primary particles of the lithium nickel cobalt composite oxide cathodematerial are that the lithium content is distributed uniformly from the surface of the secondary particle toward the core of the secondary particle, the nickel content is increased from the surface of the secondary particle toward the core of the secondary particle, and the cobalt content is decreased from the surface of the secondary particle toward the core of the secondary particle.

Therefore, an example is shown in FIG. 1, the content of lithium is uniformly distributed from A to B, the content of nickel is increased from A to B, and the content of cobalt is decreased from A to B.

The formula of the primary particle near the surface of the secondary particle A, as shown in FIG. 1, is expressed as LiₓNi_{1-y}Co_{y}O₂, wherein 0.9≦x≦1.2, and 0.15≦y≦1.0, and the formula of the primary particle at the core of the secondary particle B, as shown in FIG. 1, is expressed as Li_{x′}Ni_{1-y′}Co_{y′}O₂, wherein 0.9≦x′≦1.2, 0≦y′≦0.3, 0≦z′≦0.3 and x=x′, y>y′.

The primary particle of the secondary particle of the lithium nickel cobalt composite oxide cathode material has an average particle size 30˜700 nm. The average particle size (D₅₀) of the secondary pa e of the lithium nickel cobalt composite oxide cathode material is 0.5˜25 μm.

The cathode material is a R-3m rhombohedral structure, and the tap density of the cathode material is greater than 1.5 g/cm³, and the specific surface area of the cathode material is within 0.1˜20 m²/g.

An embodiment and a comparative example are provided as following and an analysis is conducted to illustrate the physical and electrochemical characteristics to prove the improvement in performance.

### Embodiment

### 1. Synthesis of a Lithium Nickel Cobalt Composite Oxide Cathode Material Consisting of Primary Particles With Different Chemical Compositions

A spherical nickel cobalt hydroxide was synthesized by chemical co-precipitation, and then a layer of cobalt hydroxide was uniformly coated on the surface of the spherical nickel cobalt hydroxide in a nitrogen atmosphere by chemical co-precipitation. The precursor was mixed with lithium hydroxide (LiOH.H₂O) powder. The mole ratio of lithium and sum of nickel and cobalt is 1.02:1.00. The mixture was calcined at 750° C. in an oxygen atmosphere for 12 hours, and finally the lithium nickel cobalt composite oxide cathode material is obtained, which consists of primary particles with different chemical compositions. In brief, use DC—LiNi_{0.72}Co_{0.28}O₂ in the following as the lithium nickel cobalt composite oxide cathode material synthesized by this experiment.

### 2. Electrochemical Measurements

Cathode films were prepared by mixing the DC—LiNi_{0.72}Co_{0.28}O₂ cathode material, KS6 graphite, Super-P carbon-black and polyvinylidene fluoride (PVdF), as a binder, in a 89:4:2:5 (wt. %) ratio. N-methyl pyrrolidinone (NMP) was used as the solvent. The slurry was obtained after mixing carbon-black, active material and PVdF binder with the NMP solvent. The resultant slurry was cast on 20 μm Al foil using a 200 μm on doctor blade. The coated Al foil was dried at 120° C. for 2 hours to evaporate the NMP solvent.

The coated foil was roll-pressed and punched to form a circular disk (12 mm in diameter). The loading density of electrode disk is ˜18 mg/cm². The electrode films were preserved in an argon-filled dry box. In the coin cell, the DC—LiNi_{0.72}Co_{0.18}Mn_{0.1}O₂ electrode disk served as the cathode, and the lithium metal foil functioned as the anode. A mixture of ethylene carbonate (EC), diethyl carbonate (DEC), and propylene carbonate (PC) (EC:DEC:PC=30:50:20 vol. %) solvents containing 1 M LIPF₆ was used as an electrolyte. The polypropylene membrane was soaked in the electrolyte for 24 hours prior to use.

The coin cell has a charge/discharge range of 2.8˜4.3 V, and a charge/discharge current of 0.1˜7.0 C to measure the electrochemical characteristics of DC—LiNi_{0.72}Co_{0.28}O₂ cathode material.

### 3. Thermal Evaluation

DC—LiNi_{0.72}Co_{0.28}O₂ samples for differential scanning calorimetry (DSC) were prepared as follows, Cells were initially charged to 4.3 V at a 0.1 C rate. The cells were then opened in an argon-filled dry box to remove the charged cathode samples. Approximately 3 mg of the cathode with 3 μL electrolyte was hermetically sealed in an aluminum pan. DSC scanning was carried out at a scan rate of 5° C. min⁻¹ from 180˜300° C.

### Comparative Example

### 1. Synthesis of a Lithium Nickel Cobalt Composite Oxide Cathode Material Consisting of Primary Particles With Uniform Chemical Composition

Spherical nickel cobalt hydroxide was synthesized by chemical co-precipitation, and then lithium hydroxide was added to mix together, wherein, the mole ratio of lithium and sum of nickel and cobalt is 1.02:1.00. The mixture was calcined at 750° C. in an oxygen atmosphere for 12 hours, and finally the lithium nickel cobalt composite oxide cathode material is obtained, which consists of primary particles with uniform chemical composition. In brief, use AC—LiNi_{0.72}Co_{0.28}O₂ in the following as the lithium nickel cobalt composite oxide cathode material is synthesized by the comparative example.

### 2. Electrochemical Measurements

The only difference from the above experiment, AC—LiNi_{0.72}Co_{0.28}O₂ is used as the cathode material; the other steps remain the same as the above experiment. And then, use same method to test the electrochemical characteristics of AC—LiNi_{0.72}Co_{0.28}O₂.

### 3. Thermal Evaluation

The coin cells of AC—LiNi_{0.72}Co_{0.28}O₂ were initially charged to 4.3 V at a 0.1 C rate. The cells were then opened in an argon-filled dry box to remove the charged cathode samples. Approximately 3 mg of the cathode with 3 μL electrolyte was hermetically sealed in an aluminum pan. DSC scanning was carried out at a scan rate of 5° C. min⁻¹ from 180˜300° C.

### Analysis Result

### 1. Analysis of Physical Characteristics:

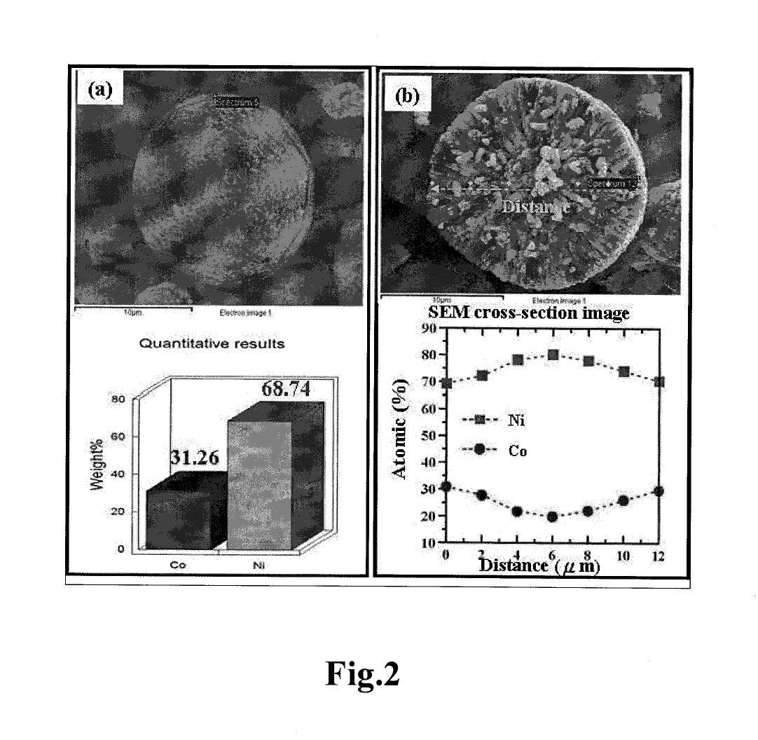

FIG. 2 illustrates the quantitative elementary analysis results of DC—LiNi_{0.72}Co_{0.28}O₂ cathode material of the present invention. The quantitative elementary analysis of the DC—LiNi_{0.72}Co_{0.28}O₂ cathode material is performed by using inductive couple plasma (ICP) and energy dispersive spectrometer (EDS) on the surface and cross section of the DC—LiNi_{0.72}Co_{0.28}O₂ cathode material.

FIG. 2(a) shows the surface morphology and the element ratio of the surface of the DC—LiNi_{0.72}Co_{0.28}O₂ cathode material, and FIG. 2(b) shows the cross section morphology and the compositional change of the cross section of the DC—LiNi_{0.72}Co_{0.28}O₂ cathode material.

The mole ratio of Ni:Co of DC—LiNi_{0.72}Co_{0.28}O₂ cathode material is measured by ICP as 72.77:27.23, As shown in FIG. 2(a), the mole ratio of Ni:Co of primary particle near the surface of DC—LiNi_{0.72}Co_{0.28}O₂ cathode material is 68.74:31.26. As shown in FIG. 2(b), Co is diffused to inner of DC—LiNi_{0.72}Co_{0.28}O₂ cathode material and the mole ratio of Ni:Co had been changed after sintering in high temperature. The mole ratio of Ni:Co of primary particle in the core of DC—LiNi_{0.72}Co_{0.28}O₂ cathode material is 80.13:19.87.

### 2. Analysis of Electrochemical Characteristics

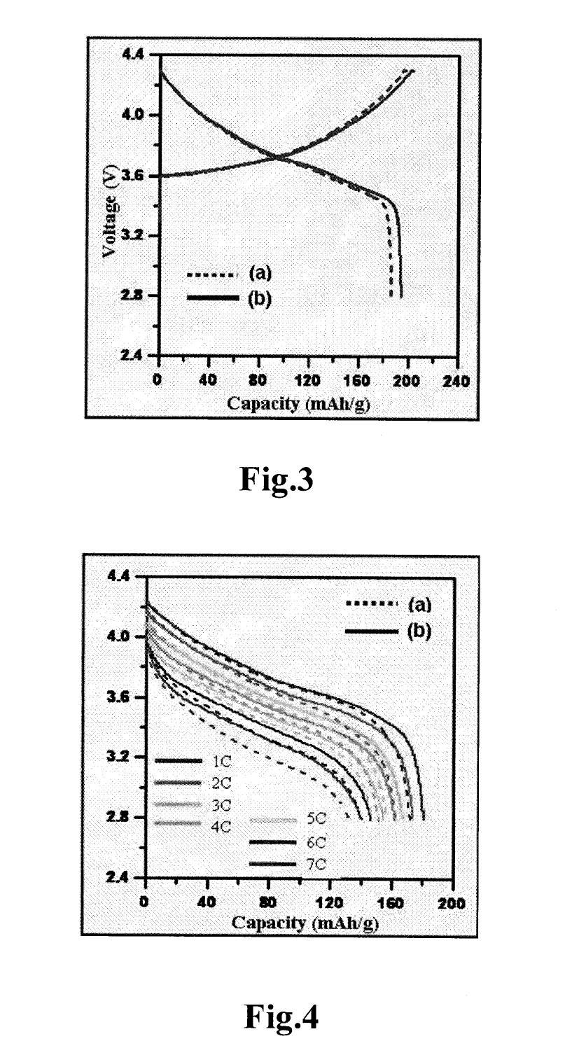

FIG. 3 is a diagram for comparing the charge/discharge electrochemical characteristics in small current between the embodiment and comparative example. The curve (a) shows the comparative example (AC—LiNi_{0.72}Co_{0.28}O₂) and the curve (b) shows the embodiment (DC—LiNi_{0.72}Co_{0.28}O₂). The difference between embodiment (DC—LiNi_{0.72}Co_{0.28}O₂) and the comparative example (AC—LiNi_{0.72}Co_{0.28}O₂) can be observed by charge/discharge in small current (0.1 C). Within the voltage range 2.8˜4.3 V. the discharge capacity of the embodiment (DC—LiNi_{0.72}Co_{0.28}O₂) is 194.3 mAh/g and irreversible capacity of the embodiment (DC—LiNi_{0.72}Co_{0.28}O₂) is 9.4 mAh/g; the discharge capacity of the comparative example (AC—LiNi_{0.72}Co_{0.28}O₂) is 185.7 mAh/g and irreversible capacity of the comparative example (AC—LiNi_{0.72}Co_{0.28}O₂) is 10.8 mAh/g.

FIG. 4 is a diagram for comparing the electrochemical characteristics of charge in various currents between the embodiment and comparative example. The curve (a) shows the comparative example (AC—LiNi_{0.72}Co_{0.28}O₂) and the curve (b) shows the embodiment (DC—LiNi_{0.72}Co_{0.28}O₂). The current conditions are charging in 0.2 C and discharging in 1 C˜7 C and the range of working voltage is 2.8˜4.3 V. It is obviously observed that the embodiment (DC—LiNi_{0.72}Co_{0.28}O₂) has a higher discharge potential plateau, which has ˜78% of origin capacity (0.1 C) under 7 C discharge; however, the comparative example (AC—LiNi_{0.7}Co_{0.28}O₂) only has ˜74% of origin capacity (0.1 C).

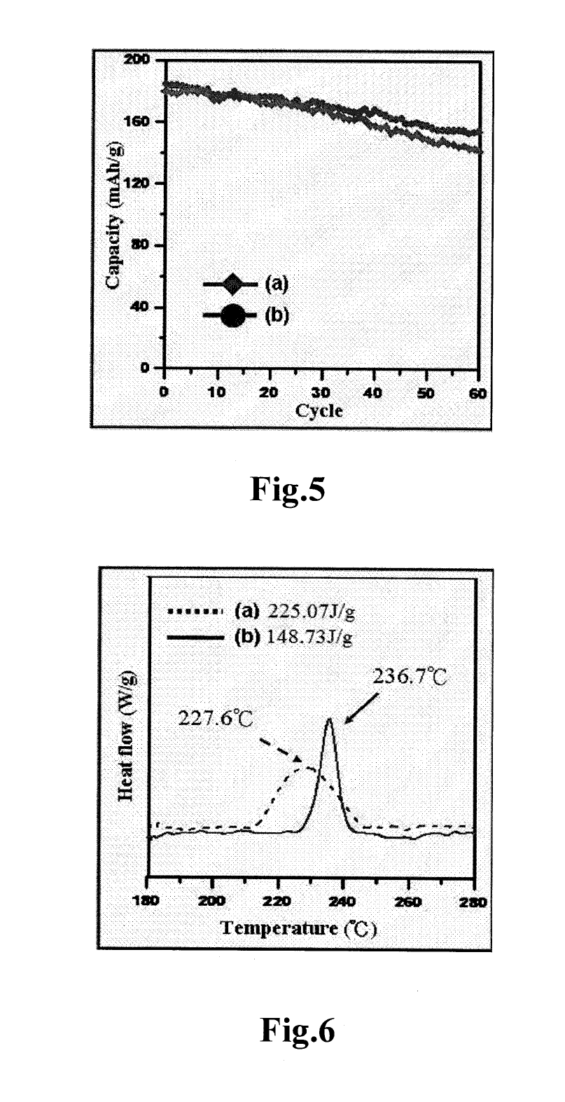

FIG. 5 is a diagram for comparing the cycle life between the embodiment and comparative example. The curve (a) shows the comparative example (AC—LiNi_{0.72}Co_{0.28}O₂)and the curve (b) shows the embodiment (DC—LiNi_{0.72}Co_{0.28}O₂), After 60 Charge/Discharge cycles under 0.5 C in voltage range 2.8˜4.3 V, it shows that the embodiment (DC—LiNi_{0.72}Co_{0.28}O₂) has ˜83.5% of initial capacity and the comparative example (AC—LiNi_{0.72}Co_{0.28}O₂) only has ˜78.5% of initial capacity. Summarizing the results described above, it can be obviously observed that the embodiment (DC—LiNi_{0.72}Co_{0.28}O₂) has better charge/discharge characteristics.

FIG. 6 is a diagram for showing DSC test of the embodiment and the comparative example. The curve (a) shows the comparative example (AC—LiNi_{0.72}Co_{0.28}O₂) and the curve (b) shows the embodiment (DC—LiNi_{0.72}Co_{0.28}O₂). The results of FIG. 6 show that the exothermic temperature of the comparative example (AC—LiNi_{0.72}Co_{0.28}O₂) is 227.6° C., and the exothermic temperature of the (DC—LiNi_{0.72}Co_{0.28}O₂) is shifted to 236.7° C. Moreover, the exothermic heat is decreased from 225.07 J/g to 148.73 J/g. Summarizing the results described above; the embodiment (DC—LiNi_{0.72}Co_{0.28}O₂) has better thermal stability.

The main technical characteristic is to provide a new lithium nickel cobalt composite oxide cathode material consisting of primary particles with different chemical compositions. Since the lithium nickel cobalt composite oxide cathode material is not formed by doping different metal ions or modification with protective layer, such that there is no obvious interface resistance in the particle and inactive regions which decreases the capacity. High thermal-stability property had been provided based on the rich Co content near the surface of the secondary particle, moreover, a high capacity had been provided based on the rich Ni content in the core of the secondary particle. The lithium nickel cobalt composite oxide cathode material of present invention has advantages of high thermal stability and high capacity, keeps the stable surface-structure stability of material, raises the safety, and does not decrease the specific capacity of the material. The present invention achieves the objects of high safety and high capacity and satisfies the demand of high power, high energy and high safety of lithium battery,

Another technical characteristic of the present invention is that lithium nickel cobalt composite oxide cathode material consisting of primary particles with different chemical compositions can be applied in lithium secondary cells, which includes the lithium battery packaging by cylindrical or prismatic stainless-steel, aluminum or aluminum alloy can. The lithium nickel cobalt composite oxide cathode material of the present invention can also be applied in the polymer lithium battery packaging by thermo-compression bonding or other packaging method with aluminum foil bag. The lithium nickel cobalt composite oxide cathode material can enhance the safety and capacity of the lithium battery.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A lithium nickel cobalt composite oxide cathode material, comprising:
a plurality of secondary particles, each of the secondary particles consisting of aggregates of fine primary particles, and each of the secondary particles including a lithium nickel cobalt composite oxide, which is expressed as LiₐNi_{1-b}Co_{b}O₂, an average chemical formula of each secondary particle satisfying one condition of 0.9≦a≦1.2, and 0.1≦b≦0.5;
wherein, the lithium nickel cobalt composite oxide has a structure with different chemical compositions of primary particles from the surface toward core of each of the secondary particles.

2. The lithium nickel cobalt composite oxide cathode material as claimed in claim 1, wherein the different chemical compositions includes lithium content uniformly distributed from the surface toward the core, nickel content increased from the surface toward the core, and cobalt content decreased from the surface toward the core in each of the secondary particles.

3. The lithium nickel cobalt composite oxide cathode material as claimed in claim 2, wherein the formula of primary particle near the surface of each secondary particle of the lithium nickel cobalt composite oxide cathode material is expressed as LiNiₓNi_{1-y}Co_{y}O₂, wherein 0.9≦x≦1.2, 0.15≦y≦1.0, and the formula of primary particle in the core of each secondary particle of the lithium nickel cobalt composite oxide cathode material is expressed as Li_{x′}Ni_{1-y′}Co_{y′}O₂, wherein 0.9≦x′≦1.2, 0≦y′≦0.3, and x=x′, y>y′.

4. The lithium nickel cobalt composite oxide cathode material as claimed in claim 3, wherein each of the primary particles has an average particle size of 30˜700 nm.

5. The lithium nickel cobalt composite oxide cathode material as claimed in claim 4, wherein each of the secondary particles has an average particle size (D₅₀) of 0.5˜25 μm.

6. The lithium nickel cobalt composite oxide cathode material as claimed in claim 1, wherein the cathode material is a R-3m rhombohedral structure.

7. The lithium nickel cobalt composite oxide cathode material as claimed in claim 1, wherein tap density of the cathode material is greater than 1.5 g/cm³.

8. The lithium nickel cobalt composite oxide cathode material as claimed in claim wherein a specific surface area of the cathode material is within 0.1˜20 m²/g.
